(19) United States
(12) Patent Application Publication
(10) Pub. No.: US 2008/0280662 A1
(43) Pub. Date: Nov. 13, 2008

(54) System for evaluating game play data generated by a digital games based learning game

(76) Inventors: Stan Matwin, Ottawa (CA); Jelber Sayyad Shirabad, Ottawa (CA); Kenton White, Ottawa (CA)

Correspondence Address: CASSAN MACLEAN, 307 GILMOUR STREET, OTTAWA, ON, K2P 0P7, CA

(21) Appl. No.: 11/798,303

(22) Filed: May 11, 2007

(51) Int. Cl. A63F 13/00

(52) U.S. Cl. 463/9; 434/336

(57) ABSTRACT

Methods and devices for assessing a user's skill level in a field of expertise based on game play data generated by that user. In one embodiment, a user plays a game which simulates an auditing interview. The user selects predefined questions to ask a computer controlled interviewee and a game log of the questions asked, reactions to the questions, and other data is created. The game log is then sent to an assessment system with multiple assessment modules. Each assessment module analyzes the game play data for specific patterns in the questions being asked. Patterns such as the sequencing of questions, the type and frequency of questions asked, and whether specific questions are asked may then be tracked and assessed. Based on the results of the various assessment analyses, a final metric indicative of the user's skill level is calculated. Advice and tips for the user to increase his skill level may also be provided based on what patterns were found in the game play data.

### FIELD OF THE INVENTION

The present invention relates to digital games based learning. More specifically, the present invention relates to methods and systems for evaluating results of a game play with a view towards determining a user's skill level in a specific field of expertise.

### BACKGROUND OF THE INVENTION

The computer revolution which started in the late 1970s has spawned a number of generations of people who are intimately familiar to computer games. It was only a matter of time before the medium of computer games or digital gaming was applied to something more useful than mere entertainment.

Marc Prensky's book, “Digital game-based learning”, (McGraw-Hill, New York, N.Y., 2001), teaches that DGBL (Digital Game Based Learning) lies at the intersection of Digital Games and E-learning. DGBL uses techniques developed in the interactive entertainment industry to make computer-based training appealing to the end-learner. DGBL delivers content in a manner which is highly attractive for today's learners, while at the same time preparing organizations for a coming shift in learner demographics. Unlike employees, business and training managers for the most part do not realize the impact and significance of video games in today's media landscape.

According to John C. Beck and Mitchell Wade's “Got Game: How the gamer generation is reshaping business forever”, (Harvard Business School Press, Boston, Mass. 2004), chances are four to one that an employee under the age of 34 has been playing video games since their teenage years. This number grows each year as more and more gamers enter the workforce. In the US, 145 million people—consumers and employees—play video games in one form or another.

While mainstream DGBL work focuses on digital games as an instrument for transferring knowledge to the learner (player), there is still a need for techniques which use digital games for the purpose of testing knowledge of the learner. This need is particularly acute in situations when the knowledge is procedural in its nature and the test is performed by a subjective expert. In these situations, what is being tested is the behavior of the user in a structured situation simulated by the game. While this aspect of the training process can be delivered relatively easily using digital games technologies, the issue of computerization of the performance evaluation of the students is an open problem which still needs to be solved.

### SUMMARY OF THE INVENTION

The present invention provides methods and devices for assessing a user's skill level in a field of expertise based on game play data generated by that user. In one embodiment, a user plays a game which simulates an auditing interview. The user selects predefined questions to ask a computer controlled interviewee and a game log of the questions asked, reactions to the questions, and other data is created. The game log is then sent to an assessment system with multiple assessment modules. Each assessment module analyzes the game play data for specific patterns in the questions being asked. Patterns such as the sequencing of questions, the type and frequency of questions asked, and whether specific questions are asked may then be tracked and assessed. Based on the results of the various assessment analyses, a final metric indicative of the user's skill level is calculated. Advice and tips for the user to increase his skill level may also be provided based on what patterns were found in the game play data.

In one aspect of the invention, there is provided a system for evaluating game play data generated by a user to determine said user's expertise in at least one specific field, the system comprising:

an input module for receiving previously completed game play data;

at least one assessment module for assessing said game play data, the or each assessment module generating assessment output based on said game play data

a collation module for receiving said assessment output from said at least one assessment module, said collation module outputting collation output, at least a portion of said collation output being indicative of said user's expertise in said at least one specific field, said collation output being based on said assessment output received from said at least one assessment module.

In another aspect of the invention, there is provided a system for evaluating game play data generated by a user when playing a game to determine said user's expertise in a specific field, the system comprising:

an input module for receiving previously completed game play data

a plurality of assessment modules for independently assessing said game play data, each assessment module generating an assessment metric for said game play data based on whether said game play data conforms to a predefined set of rules and criteria, each assessment module's predefined rules and criteria being different from those of other assessment modules

a collation module for receiving said assessment metric from each of said plurality of assessment modules, said collation module calculating at least one final metric indicative of said user's expertise in said specific field, said final metric being based on multiple assessment metrics.

### BRIEF DESCRIPTION OF THE DRAWINGS

A better understanding of the invention will be obtained by considering the detailed description below, with reference to the following drawings in which:

FIG. 1 is a block diagram of a DGBL system of which the invention is a part

FIG. 2 illustrates a visual interface for the DGBL game with which the user interacts

FIG. 3 is a sample game log illustrating the various fields of data saved from the user's gaming session

FIG. 4 is a block diagram illustrating the components of the assessment system illustrated in FIG. 1

FIG. 5 is a flowchart illustrating the various steps in the method executed by the assessment system.

### DETAILED DESCRIPTION

In what follows, an exemplary digital game system and evaluation system for evaluating the game results specifically addressing the issue of skills assessment for the purpose of auditor certification are disclosed. The present disclosure teaches how student performance evaluation can be approached and solved as a classification problem, and it is advantageously shown that subjective evaluation can be computerized in a scaleable manner, i.e. to evaluate thousands of students per day. One embodiment of such an evaluation system is described, teaching various approaches which may be used by a person of ordinary skill in the art in order to systematically practice the invention and show results delivered by the exemplary system. The lessons and concepts learned by a person having ordinary skill in the art from this disclosure enable the development of an industrial-grade, reusable and scaleable DGBL solution for personnel certification.

Auditor training and certification is a particularly interesting application for DGBL. Typically, a potential lead auditor goes on a five-day training course to understand the specific details of the management system that they wish to be certified to. The training focuses on knowledge transfer and some acquisition of skills and behaviors using, for example, role playing and even a limited practice audit in a real organization. Following training, auditor competences are examined through an on-site assessment. In this assessment an external examiner watches an auditor perform their job, grading the auditor based on the examiner's subjective experience. Such examination/testing mode is critical for personnel certification programmes. ISO 17024 (General requirement for bodies operating certification of persons) requires that competency is measured on outputs (exam scores, feedback from skills examiners etc) not on inputs (number of days attending training course, number of years experience).

DGBL has the advantage of removing key issues traditionally associated with assessment of auditor competence by one-on-one assessment, namely conflict of interest and examiner-to-examiner subjectivity. The environment in DGBL is standardized and the comparison is to standards and opinions from a group of expert auditors, not to a single auditor.

With this approach, both the knowledge an auditor needs to perform an audit (by examining a defined standard) and what competences are required in the audit itself need to be defined. For example:

asking the appropriate type of question, e.g. open or closed

interpreting answers to guide the direction of the audit

covering the scope of the audit in an allotted timeframe

reacting to changes in body language of an audit subject—a character in the game (for example, choosing appropriate questions in response to the perceived mood of the auditee)

spotting relevant information within the environment being audited (for example, the company says they promote an egalitarian environment, but employee parking is miles away from executive parking)

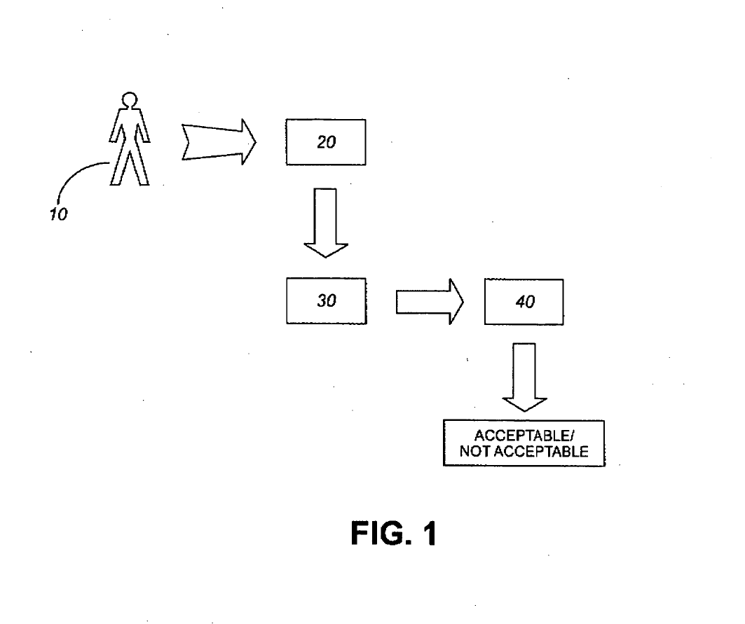

Referring to FIG. 1, a DGBL system is illustrated. A user 10, whose skills are to be assessed, plays a game 20. The game results 30 are then transmitted to an assessment system 40 which assesses the results 30. The assessment system 40 then provides an indication of whether the user's skills are acceptable or not. Ideally, the assessment system also provides tips and advice to the user 10 on how the user may improve his or her skills.

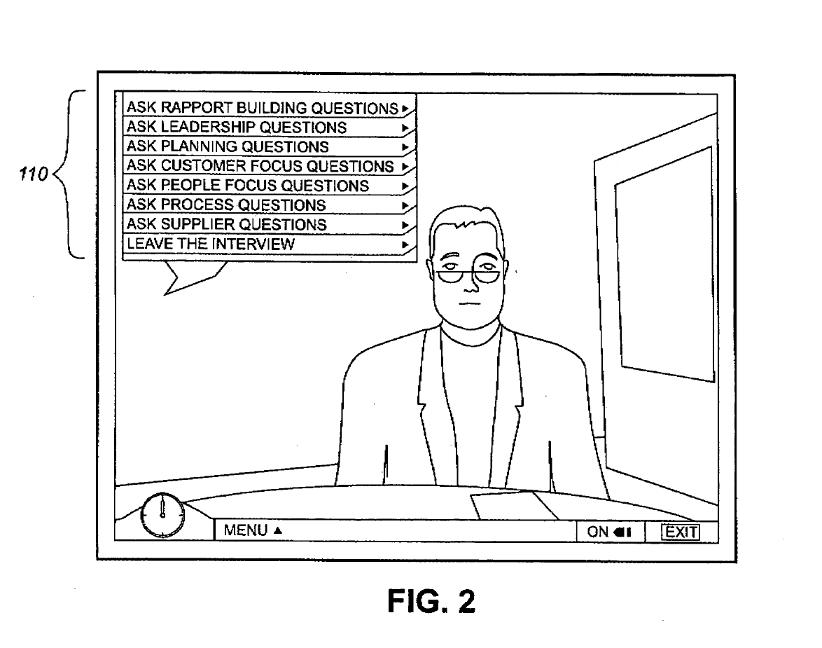

As noted above, in one implementation of a DGBL system, the skills being assessed are that of an auditor and the game being played is a simulation of a company audit. The user takes on the role of an auditor and, as such, interviews various personnel in the company being audited. The game provides a visual interface (see FIG. 2 as a sample) so that the user may take visual cues for a more thorough audit. The aim of the game is for the user to complete an audit within an allotted time. The audit is conducted by having the user ask various questions of the interviewee(s) and to note the answers. The user is expected to take note of the answers and to treat the audit as if it was a real audit. The user's skills as an auditor can then be assessed by the questions that the user asks of the interviewee. A the end of the game, the user will participate in the scoring of the company based on the responses the user received from the interviewee.

The interviewee is a non-playing character (NPC) controlled by the computer and, depending on the questions being asked by the user, may react in a visual manner to the interviewer. The venue of the interview, as defined by the user interface, may also provide visual cues for the interviewer regarding the company under audit. As an example, incorrectly filled out labels or other erroneous documents and signs or dilapidated surroundings may be part of the visual interface. Such visual cues may lead the user to topics and questions that he may wish to explore with the interviewee.

Regarding the questions, the user may select predefined questions from a menu. As can be seen from FIG. 2, a menu 110 provides groupings under which the questions may be organized. There are no guidelines or rules regarding the order that the user may ask the questions. As such, the user may ask any of the predefined questions of the interviewee at any time.

It should be noted that the game is set up so that each predefined question is provided with predefined answers, any one of which may be provided by the interviewee to the user. The questions are also set up in a database, with each question being provided with tags that signify what type of question it is, what category the question is in, and what possible answers may be provided to the question. It should be noted that a question may have more than one tag as a question may belong to multiple types.

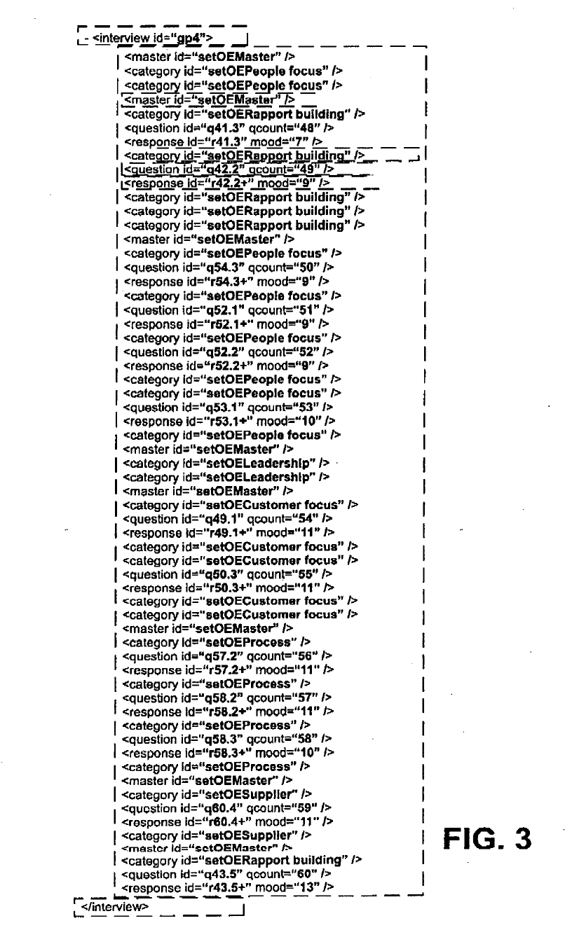

As the user plays the game, each question he selects to ask the interviewee is noted and a complete record of the interview is compiled in a game log as the game play data. Each question asked by the user is logged along with the response given by the interviewee, the question's place in the sequence of questions asked of the interviewee, and the category to which the question belongs. Also, an indication of the interviewee's “mood” is provided in the game log. The “mood” of the interviewee may be indicated by an integer value which may increase or decrease depending on the question asked. Ideally, once the mood value passes certain thresholds, the visual image of the interviewee seen by the user changes to reflect the positiveness or negativeness represented by the mood value. A sample game log is illustrated in FIG. 3 showing the various data captured in the game log.

Once the game log or the game play data has been gathered, this data may be used with the assessment system 40. Ideally, the question database used by the game 20 is available to or is duplicated with the assessment system 40 as the classifications or categorization of the questions may be used by the assessment system 40.

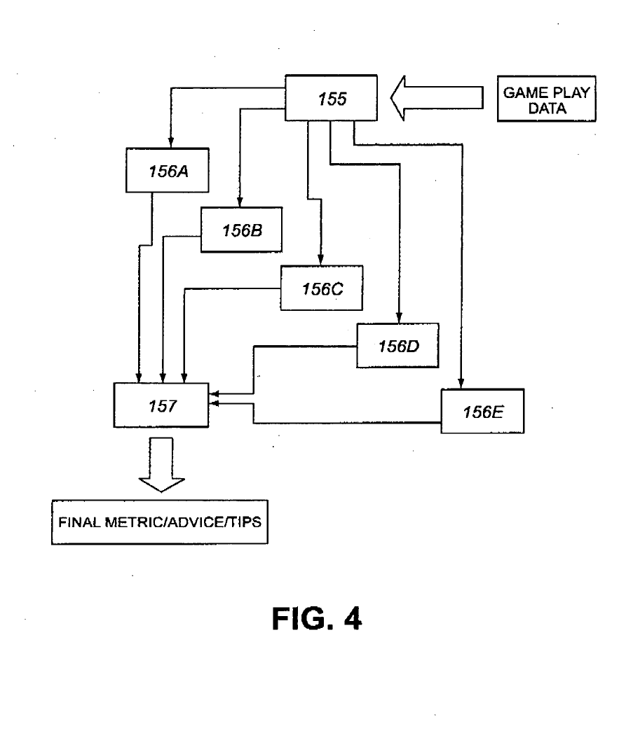

The components of the assessment system 40 are illustrated in FIG. 4. As can be seen, the system 40 consists of an input module 155, a number of assessment modules 156a, 156b, 156c, 156d, 156e, 156f, and a collation module 157. The input module 155 receives the game play data and performs formatting functions and other preliminary preprocessing which may be required. The preprocessed data is then transmitted to the various assessment modules. The assessment modules assesses the game play data based on preprogrammed patterns, rules, and criteria in the assessment modules. Each of the assessment modules then produces an assessment metric (an assessment output) based on its assessment of the game play data. Since each assessment module assesses a different skill or capability of the user, the various assessment metrics, taken together, provides a complete picture of the user's skill or capability level. The assessment metric produced by the assessment modules may also contain data tags that indicate patterns found in the game play data by the assessment modules. These data tags may then be used to provide the user with advice or tips on how he or she may improve his or her skills.

The assessment metrics and any data tags associated with them are then received by the collation module 157. The collation module 157 can, based on preprogrammed preferences weigh the various assessment metrics to result in a final metric. Depending on the designer's preferences, perhaps reached after consultations with experts in the field of expertise being tested, the contribution of a particular assessment metric to the final metric may be weighted accordingly as some assessment metrics may be seen as more important than other assessment metrics to the overall skill level of the user.

Regarding the data tags associated with the various assessment metrics, each tag can be associated with a specific shortcoming of the user or a specific area in which the user seemingly lacks expertise. Since these specific shortcomings or areas are predefined, specific advice or tips to the user can be easily provided along with the final metric. If, depending on the implementation, a final metric is not to be provided to the user, a threshold for the final metric may be defined with users having a final metric which meet or exceed the threshold being adjudged under one classification while users whose metrics do not meet the threshold are determined to be of another classification. In one implementation, users whose final metric exceed the threshold were classified as expert while others whose metrics did not were classified as non-expert.

As noted above, the various assessment modules assess different skills evidenced (or not) by the user in his or her questioning of the interviewee. Ideally, each assessment module analyzes the game play data, extracts the data required and, based on the preprogrammed preferences in the assessment module, provides a suitable assessment metric. The preprogrammed preferences in the assessment module are ideally determined from consultations with experts in the field of expertise being tested and from determining patterns in game play data generated by these experts when they play the game noted above.

One example of such an assessment module would be one which determines patterns in question sequencing that the user exhibits. For example, if questions were categorized, in one classification, as either open ended questions (e.g. usually requiring longer answers) or closed ended (e.g. one requiring a mere yes or no answer), then patterns in the question sequencing can be derived from the game play data. If, in the game play data, open ended questions were tagged with a “1” value while closed ended questions were tagged with a “0” value, transitions between asking open and close ended questions are relatively simple to detect. The assessment module attempting to detect patterns in question sequencing merely has to detect transitions in the tag values between sequential questions. A transition from a “0” value to a “1” value between succeeding questions means that a closed ended question was followed by an open ended question. Similarly, a transition from a “1” value to a “0” value between succeeding question means that an open ended question was followed by a closed ended question. The number of such transitions may be counted and this count may form the basis of the assessment metric for this module. As a further note, if a closed question to an open question transition occurred between questions that were from the same category (e.g. both questions were from the “Supply Questions” category or from a “Leadership Questions” category), then this may merely mean that the user is seeking further detail to a response to the open ended question. Transitions and sequencing such as this may be counted and, again, this may form the basis of an assessment metric. Again, instances such as this may be counted with the count contributing towards an assessment metric.

Another example of sequencing which the assessment module may track is that of specific question sequencing. By hard coding specific sequences of questions which the assessment module will seek from the game play data, a more concrete picture of the user's skills may be obtained. As an example, if asking question X is followed by asking question Y and then question Z is considered to be a good indication of a higher level of a user's skill, then if this sequence of questions is found in the game log, then a higher assessment metric may be awarded. Or, detecting the presence of such a specific sequence of questions in the game log may increment a counter value maintained by the assessment module, with the assessment metric being derived from the final counter value. The assessment module may, of course, seek to determine multiple specific questions sequences, with the presence of each specific question sequence contributing to the assessment metric for that module.

Instead of question sequences, an assessment module may merely try to determine if specific questions were asked. As an example, if the visual interface has “hot spots” or visual cues which the user is supposed to notice (e.g. the incorrectly filled out labels and erroneous documents mentioned above), then questions relating to these cues should be asked of the interviewee. Thus, if the game play data indicates that the user asked specific questions regarding these visual cues, then, for the assessment module assessing this aspect of the user's skills, the assessment metric produced may be higher. Similarly, if a response given by the interviewee clearly prompts for a further question regarding a specific topic, then the presence of that question in the game play data should result in a higher assessment metric. Of course, if some of these specific questions which should have been asked were NOT asked, then this may also have a negative impact on the assessment metric.

Since the interviewee has a visual manifestation which the user can see and which can change according to the mood value, the user's receptiveness to this mood can also be assessed and/or tracked. As an example, if the mood value significantly changes after a question and the user's questions do not change either in type or category over the next (e.g. the user persisting in asking closed type questions from the same category), then this may evidence a lack of concern for the interviewee or a blindness to the shift in the interviewee's mood. Such an occurrence may, depending on the qualities and skills judged to be desirable, result in a lower assessment metric from the assessment module.

Another pattern which may be sought for would be preference in question type. The assessment module may simply count the number of open ended questions asked along with the number of closed ended questions. If open ended questions are judged to be more preferable, then a user asking more open ended questions than closed ended questions may be given a higher assessment metric from the assessment metric assessing this particular pattern. The assessment metric may be as simple as a percentage of open ended questions compared to the total number of questions asked. Similarly, if the user asked mostly questions from a particular category as opposed to another (e.g. more questions from the “Supply Questions” category were asked than from the “Leadership Questions” category), then this could indicate an imbalance in the approach taken by the user. If this imbalance is determined, by expert opinion, to be undesirable, then this imbalance can be reflected in a lower assessment metric.

Along with the assessment metrics, the assessment modules may provide the collation module with specific, predetermined and preconfigured tags based on the patterns that the assessment modules found in the game play data. These tags would act as flags for the collation module so that specific advice and/or tips to the user may be given based on the game play data generated by the user. As an example, if the user's game play data indicated that the user asked too many closed ended questions, then a specific tag would be generated to indicated this. Similarly, if the user tended to ask too many questions from a specific category, then a specific tag would be generated so that this tendency would be brought to the user's attention.

Once the assessment modules have provided their assessment metrics and their tags, the collation module can therefore collate all the data and perform the final determination to arrive at the final metric. As noted above, this final metric would be derived from the various assessment metrics from the assessment modules. The final metric would be a reflection of the relative importance of the various patterns being searched for by the assessment modules. For example, if it has been determined that being able to recognize the visual cues from the visual interface was very important, then the assessment metrics from that assessment module may be weighted so that it contributes to a quarter of the final metric. Similarly, if asking open ended questions is determined to not be as important, then the assessment metrics from that assessment module dealing with counting open ended/closed ended questions may be weighted to only count for fifteen percent of the total final metric. Clearly, the assessment metrics are labelled so that their source assessment module is identified to the collation module. This simplifies the weighting procedure.

The collation module also receives the tags noted above from the various assessment modules. Based on which predetermined tags have been received, the collation module can retrieve the predetermined and prepackaged advice (in human readable format) corresponding to the received tags. Such prepackaged advice may be stored in, as noted above, the database for the questions. As examples of predetermined and prepackaged advice, the following advice/tips may be provided to the user if the following patterns were found by the assessment modules from the game play data:

Pattern: Question regarding specific visual cues were not asked

Advice: Be more attentive and observant.

Pattern: Questions asked did not change even after mood of interviewee significantly changed

Advice: Be observant of the interviewee and try to pick up non-verbal cues

Pattern: Too many closed questions asked

Advice: Add more open ended questions

Alternatively, instead of providing advice to the user on how to achieve better results in the game, the collation module may provide as part of its collation output, advice in human readable format to those determining certification regarding the user's performance. Thus, instead of outputting advice such as “Ask less close ended questions”, the collation module could output “This user is not an expert because he/she asked too many close ended questions”. The collation module can therefore provide predetermined conclusions regarding the user based on the user's game play data to those who may make the final decision about the user's level of expertise. Such output, whether it be conclusionary or in the form of advice, may be given to either the user or the administrators of the game.

As noted above, the rules/criteria and patterns sought in the game play data are determined after consultations with experts in the field for which the skills are being tested. If auditing skills are being tested, then expert auditors would need to be consulted. Also, expert auditors would, preferably, also play the game with their game play data being analyzed for patterns. Such patterns from so-called expert game play data in conjunction with the consultations with the experts should provide a suitable basis for determining which patterns and criteria the assessment modules are to look for. Also, the weighting of the various assessment metrics would have to be determined after consulting with experts. Such a consultation would reveal which qualities are most important to the overall field/skill level being tested.

It should, however, be noted that the rules/criteria and patterns sought in the game play data may also be determined using well-known data mining techniques and machine learning processes. Such techniques and processes may be used on game play data generated by experts and non-experts in the field (or fields) of expertise being tested by the game. These can be used to generate models or patterns of what should be found in the game play data (from the expert generated game play data) and what should not be found (from the non-expert generated game play data). These models from which the sets of rules and/or criteria may be derived from may be further refined by consultations with the above noted experts.

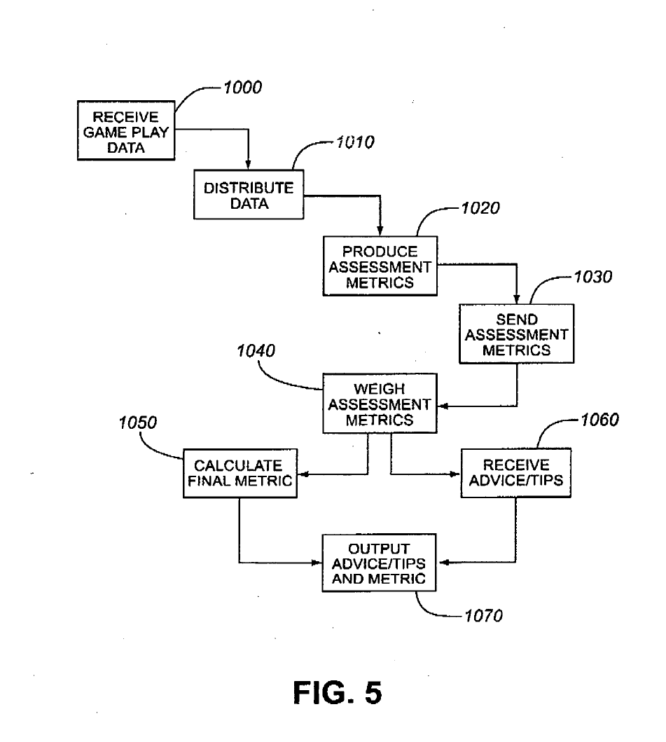

The assessment system carries out the process summarized in the flowchart of FIG. 5. The process begins with step 1000, that of receiving the game play data for a specific user. Step 1010 is that of distributing the preprocessed game play data to the various assessment modules. The assessment modules then perform their functions and produce assessment metrics (step 1020). These assessment metrics are transmitted to the collation module (step 1030). The collation module then weighs the various assessment metrics (step 1040) and arrives at the final metric (step 1050). If an expert/non-expert categorization is desired, then such a categorization may be made based on the final metric. Simultaneously, the various tags from the assessment modules are also received (step 1030) and the relevant prepackaged advice/tips are retrieved (step 1060). These are given to the user at the same time as the final metric or the final categorization as the case may be (step 1070).

To provide greater flexibility in terms of the final output, the collation module may, instead of providing a final metric, as part of its collation output, provide a breakdown of the various assessment metrics to the user with an indication of what pattern/rule was being sought for and whether the user's performance met or exceeded a desired threshold. As an example, if the assessment metric for observing and following up on visual cues is fairly high, then, for that specific skill, the user may be qualified as an expert. Similarly, if the game play data indicates that the user asks too many closed ended questions, then, from that point of view, the user may be seen as a non-expert. This categorization, for that specific skill, can be reported to the user. Also, instead of only a single final metric, the collation module may also output various final metrics, each final metric being related to different aspects of the user's performance in the game.

While the above described embodiment uses a simulation of an interview as the form of the game which produces a user's game play data, other forms of games may also be used. Specifically, the above described invention may be used in conjunction with games in which the user selects or chooses from a predetermined list of options. In the above described embodiment, the options selected by the user are questions which the user would ask an auditee if the user were an auditor. Other similar games may have the user selecting predefined actions, procedures, instructions, or reactions. When used with such games, the record of the user's selections (whether they be procedures, actions, reactions, etc.) may be used as the game play data to be assessed by the assessment modules.

In one embodiment, the game involves actions which are assigned to employees. In this game, the user acts as a human resources (HR) manager and selects an employee in a virtual company to perform a task. The list of tasks available for that employee is a subset of tasks from a larger list. For example, the quality manager would have a list of tasks that relate to quality activities, such as “implement ad quality management system” and “issue a product recall”. Different tasks would be available to the HR manager. The player must assign tasks to the virtual employees by clicking on each employee and then selecting the task from a list. Following the selection of the task, the player is given a brief summary of the results of the task. Each task will change some aspect of the company, such as Business Excellence. When the player is finished, the actions/selections of the player as well as the results are sent to the assessment component for analysis.

In another embodiment, the game involves having the player/user select procedures and processes for emergency planning. In this game the player is creating an emergency plan. For each potential emergency situation, the player creates a plan by choosing procedures from a fixed list. For example, the player may create a plan for a fire emergency be selecting the procedures “sound alarm”, “call emergency personnel”, “evacuate building”, and “sweep premises”. The same procedure may be used for multiple emergencies. “Sound alarm” could be used as part of the plan for a fire emergency, flood emergency, and earthquake emergency. Each plan constructed by the user is then sent to the assessment component for analysis as the game play data.

Another embodiment involves a game where the player selects actions from a fixed list of possible actions. Such a game could be a branching story type game, where, at each branch point, the player selects an action or choice as to how to proceed. In such a game, the player may be given two doors to enter, e.g. door 1 and door 2. The player/user then selects which door to enter. This selection moves the game onto a different story track. The list of actions that the player took throughout the game can be analyzed by the assessment component as the game play data.

A further embodiment concerns a game where the player is reacting to events in real time. These events could be portions of a court testimony, where the player must choose an objection to make (or not make an objection) from a predetermined list of possible objections. These events could be part of an emergency simulation, where new problems arise in real time and the player must choose appropriate responses to each problem from a predetermined list of possible responses. The generated list of reactions to the real time events can then be analyzed by the assessment component as the game play data.

It should be noted that, while the embodiment described above uses multiple assessment modules, other embodiments which use at least one assessment module are possible. Furthermore, the predefined set of rules and/or criteria used by each assessment module may be different from other assessment modules and may relate to different aspects of the user's expertise. As an example, using a single set of game play data, the assessment modules may assess the user's level of competence in multiple fields of expertise as opposed to merely assessing a single field of expertise.

The assessment modules may also, depending on the field being assessed, use varying sets of rules and/or criteria. An assessment module may have, depending on the configuration, as few as a single rule in its set of rules or it may have multiple, intersecting rules.

The assessment output of each assessment module may be made up of not just the assessment metric but, as noted above, tags and other data which can be used by the collation module in providing human readable advice or tips regarding the user's performance in the game based on the game play data.

As noted above, the collation module may be configured to output, as part of its collation output, multiple final metrics and different advice/tips in human readable format.

Embodiments of the invention may be implemented in any conventional computer programming language. For example, preferred embodiments may be implemented in a procedural programming language (e.g. “C”) or an object oriented language (e.g. “C++”). Alternative embodiments of the invention may be implemented as pre-programmed hardware elements, other related components, or as a combination of hardware and software components.

Embodiments can be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

What is claimed is:

1. A system for evaluating game play data generated by a user to determine said user's expertise in at least one specific field, the system comprising:
an input module for receiving previously completed game play data;
at least one assessment module for assessing said game play data, the or each assessment module generating assessment output based on said game play data
a collation module for receiving said assessment output from said at least one assessment module, said collation module outputting collation output, at least a portion of said collation output being indicative of said user's expertise in said at least one specific field, said collation output being based on said assessment output received from said at least one assessment module.

2. A system according to claim 1 wherein said game play data is generated by said user playing a game wherein said user selects from a predetermined set of options.

3. A system according to claim 2 wherein said game play data comprises a record of selections made by said user in said game.

4. A system according to claim 1 wherein said collation output comprises predetermined human readable advice relating to said user's performance in said game.

5. A system according to claim 1 wherein, for the or each assessment module, said assessment output is generated based on whether said game play data conforms to a predetermined set of rules.

6. A system for evaluating game play data generated by a user when playing a game to determine said user's expertise in a specific field, the system comprising
an input module for receiving previously completed game play data
a plurality of assessment modules for independently assessing said game play data, each assessment module generating an assessment metric for said game play data based on whether said game play data conforms to a predefined set of rules and criteria, each assessment module's predefined rules and criteria being different from those of other assessment modules
a collation module for receiving said assessment metric from each of said plurality of assessment modules, said collation module calculating at least one final metric indicative of said user's expertise in said specific field, said final metric being based on multiple assessment metrics.

7. A system according to claim 6 wherein said game play data comprises a record of selections chosen by said user while playing said game.

8. A system according to claim 7 wherein said selections made by said user are from predefined options.

9. A system according to claim 6 wherein for each assessment module, said set of predefined rules and criteria is based on game play data generated by at least one expert in said specific field playing said game.

10. A system according to claim 6 wherein said predefined set of rules and criteria is based on data generated by at least one expert in said specific field concerning said specific field.

11. A system according to claim 7 wherein each selection made by said user is labelled in said game play data according to a type of said selection.

12. A system according to claim 7 wherein each selection made by said user is labelled according to a category of said selection.

13. A system according to claim 7 wherein said record of selections comprises said selections chosen by said user in the sequence they were chosen by said user.

14. A system according to claim 6 wherein at least one of said plurality of assessment modules generates its assessment metric based on a sequence of selections chosen by said user when playing said game.

15. A system according to claim 6 wherein at least one of said plurality of assessment modules generates its assessment metric based on whether said user chose specific selections when playing said game.

16. A system according to claim 6 wherein at least one of said plurality of assessment modules generates its assessment metric based on how many selections of a specific type were chosen by said user when playing said game.

17. A system according to claim 6 wherein at least one of said plurality of assessment modules generates its assessment metric based on whether selections chosen by said user reflects events occurring in said game.

18. A system according to claim 6 wherein said collation module provides predefined advice in human readable format based on data received from said assessment modules, said advice being related to said user's game play data.

19. A system according to claim 6 wherein said game comprises at least one element chosen from a group comprising:
a simulation of an interview;
actions assigned to employees;
procedures for emergency planning;
actions related to real-time game events; and
responses in an emergency simulation.
